(19) United States
(12) Patent Application Publication
(10) Pub. No.: US 2024/0012524 A1
(43) Pub. Date: Jan. 11, 2024

(54) Antenna in a Capacitance Module

(71) Applicant: Cirque Corporation, Sandy, UT (US)

(72) Inventors: Tyler Smith, American Fork, UT (US); Brian Monson, Farmington, UT (US)

(73) Assignee: Cirque Corporation, Sandy, UT (US)

(21) Appl. No.: 17/858,379

(22) Filed: Jul. 6, 2022

(51) Int. Cl. G06F 3/044; H01Q 1/52; H01Q 1/22; H04B 5/00

(52) U.S. Cl. CPC G06F 3/0446; G06F 3/0445; H01Q 1/526; H01Q 1/2266; H04B 5/0012

(57) ABSTRACT

An apparatus may include a stack of layers, the stack including a shield layer with a first surface, at least one capacitive sensor layer having at least one set of electrodes, which capacitive sensor layer is disposed within a first portion of the stack of layers, where the first portion of the stack of layers is located adjacent to the first surface of the shield layer, and an antenna incorporated in the first portion of the stack of layers.

### FIELD OF THE DISCLOSURE

This disclosure relates generally to systems and methods for capacitance modules, such as a touch pad module. In particular, this disclosure relates to systems and methods for enabling radio frequencies to transmit and receive at the capacitance module.

### BACKGROUND

Touch pads are often included on processor-based devices, such as laptop computers or the like, in order to allow a user to use fingers, styli, or the like as a source of input and selection. Additionally, processor-based devices often include radio frequency (e.g., 3 MHz-30 GHz) transmitters, receivers, transceivers, or the like (collectively, “transceivers” herein) for Wi-Fi, Bluetooth, near field communications (NFC), or the like. However, capacitive touch pads often require electrical shielding to prevent noise from the processor-based device from interfering with normal touch pad functions. When in proximity to the radio transceiver, that shielding may prevent transmission and reception of the radio frequencies.

For example, a touch pad might be the only opening in the chassis of a processor-based device (such as a laptop) and that single opening may be used for multiple purposes, such as sending and receiving Wi-Fi or NFC communications. Existing devices may place the radio frequency antenna near (e.g., underneath) the touch pad and hatch the touch pad ground plane shielding to allow some of the radio frequencies through the shielding. However, this approach often requires tuning the antenna to transmit through the shielding and tuning is often difficult. Further, the antenna system will likely waste more power than a typical installation and the performance of the touch pad may be still affected. Additionally, the above-described system may be more difficult to manufacture due to variations in the touch pad printed circuit board (PCB) affecting the antenna resonance. Other drawbacks, inconveniences, and issues with existing devices and methods also exist.

### SUMMARY

In one embodiment, an apparatus may include a stack of layers, including a shield layer with a first surface, at least one capacitive sensor layer which has at least one set of electrodes which are in communication with processing resources, the sensor layer being disposed within a first portion of the stack where the first portion of the stack is located adjacent to the first surface of the shield layer, the processing resources being programmed to operate at least one set of electrodes within a first frequency range, and an antenna incorporated in the first portion of the stack of layers which is in communication with the processing resources, the processing resources also being programmed to operate the antenna within a second frequency range that is different from the first frequency range.

The processing resources may have a controller that includes antenna logic and capacitance logic.

The processing resources may drive an analog signal on the capacitive sensor and drive a digital signal on the antenna.

The antenna may be formed on an antenna layer in the stack of layers.

At least one sensor layer may include a first sensor layer and a second sensor layer, and the antenna may be between the first sensor layer and the second sensor layer.

The antenna may be deposited on at least one sensor layer.

The antenna may be within a capacitance sensing region of that layer.

The antenna is deposited on a sensor layer, it may be outside a capacitance sensing region of that layer.

The first frequency range and second frequency range may be offset from each other.

The first frequency range and second frequency range may overlap each other.

The antenna may be configured to transmit a wireless signal according to a Wi-Fi protocol.

The antenna may be configured to transmit a wireless signal according to a short-range wireless protocol.

The antenna may be configured to transmit a wireless signal according to a Near Field Communication (NFC) protocol.

The apparatus may be a capacitance display screen.

The first and second set of electrodes may be formed on the same layer to form one sensor layer.

The shield layer may be combined with a component layer to form a combined shield-component layer.

The first and second electrode layers in at least one capacitive sensor layer may include a mutual capacitance sensor.

The first and second electrode layers in at least one capacitive sensor layer may include a self-capacitance sensor.

In one embodiment, a method for transmitting a wireless transmission may include transmitting a signal with an antenna incorporated into a capacitance sensor stack, the antenna being on a first side of a shield layer, where the signal is within a first frequency range, and transmitting a signal on an electrode incorporated into the capacitance sensor stack, the electrode being on the first side of a shield layer, where the signal is within a second frequency range which is different than the first frequency range.

In one embodiment, an apparatus may include a stack of layers, the stack including a shield layer with a first surface, at least one capacitive sensor layer having at least one set of electrodes, which capacitive sensor layer is disposed within a first portion of the stack of layers, where the first portion of the stack of layers is located adjacent to the first surface of the shield layer, and an antenna incorporated in the first portion of the stack of layers.

### BRIEF DESCRIPTION OF THE DRAWINGS

FIG. 1 depicts an example of an electronic device in accordance with the disclosure.

FIG. 2 depicts an example of a substrate with a first set of electrodes and a second set of electrodes in accordance with the disclosure.

FIG. 3 depicts an example of a capacitance module in accordance with the disclosure.

FIG. 4 depicts an example of a capacitance display screen in accordance with the disclosure.

FIG. 5 depicts an example of a stack of layers in accordance with the disclosure.

FIG. 6 depicts an example of a stack of layers in accordance with the disclosure.

FIG. 7 depicts an example of a stack of layers in accordance with the disclosure.

FIG. 8 depicts an example of a stack of layers in accordance with the disclosure.

FIG. 9 depicts an example of a stack of layers in accordance with the disclosure.

FIG. 10 depicts an example of a stack of layers in accordance with the disclosure.

FIG. 11 depicts an example of a stack of layers in accordance with the disclosure.

FIG. 12a depicts an example of an antenna layer and sensor layer in accordance with the disclosure.

FIG. 12b depicts an example of an antenna formed on a sensor layer in accordance with the disclosure.

FIG. 13a depicts an example of sensor layers in accordance with the disclosure.

FIG. 13b depicts an example of a sensor layer in accordance with the disclosure.

FIG. 14 depicts an example of sensor layers in accordance with the disclosure.

FIG. 15 depicts an example of a capacitance module in accordance with the disclosure.

FIG. 16 depicts an example of a capacitance module in accordance with the disclosure.

FIG. 17a depicts an example of a stack of layers in accordance with the disclosure.

FIG. 17b depicts an example of multiple signals in accordance with the disclosure.

FIG. 18 depicts a method for transmitting a wireless signal in accordance with the disclosure.

### DETAILED DESCRIPTION OF THE INVENTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” may generally refer to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, electrode, or portions thereof, and the term “Rx” generally refers to a sense line, electrode, or portions thereof.

For the purposes of this disclosure, the term “electronic device” may generally refer to devices that can be transported and include a battery and electronic components. Examples may include a laptop, a desktop, a mobile phone, an electronic tablet, a personal digital device, a watch, a gaming controller, a gaming wearable device, a wearable device, a measurement device, an automation device, a security device, a display, a vehicle, an infotainment system, an audio system, a control panel, another type of device, an athletic tracking device, a tracking device, a card reader, a purchasing station, a kiosk, or combinations thereof.

It should be understood that use of the terms “capacitance module,” “touch pad” and “touch sensor” throughout this document may be used interchangeably with “capacitive touch sensor,” “capacitive sensor,” “capacitance sensor,” “capacitive touch and proximity sensor,” “proximity sensor,” “touch and proximity sensor,” “touch panel,” “trackpad,” “touch pad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

In some cases, the capacitance module is located within a housing. The capacitance module may be underneath the housing and capable of detecting objects outside of the housing. In examples, where the capacitance module can detect changes in capacitance through a housing, the housing is a capacitance reference surface. For example, the capacitance module may be disclosed within a cavity formed by a keyboard housing of a computer, such as a laptop or other type of computing device, and the sensor may be disposed underneath a surface of the keyboard housing. In such an example, the keyboard housing adjacent to the capacitance module is the capacitance reference surface. In some examples, an opening may be formed in the housing, and an overlay may be positioned within the opening. In this example, the overlay is the capacitance reference surface. In such an example, the capacitance module may be positioned adjacent to a backside of the overlay, and the capacitance module may sense the presence of the object through the thickness of the overlay. For the purposes of this disclosure, the term “reference surface” may generally refer to a surface through which a pressure sensor, a capacitance sensor, or another type of sensor is positioned to sense a pressure, a presence, a position, a touch, a proximity, a capacitance, a magnetic property, an electric property, another type of property, or another characteristic, or combinations thereof that indicates an input. For example, the reference surface may be a housing, an overlay, or another type of surface through which the input is sensed. In some examples, the reference surface has no moving parts. In some examples, the reference surface may be made of any appropriate type of material, including, but not limited to, plastics, glass, a dielectric material, a metal, another type of material, or combinations thereof.

For the purposes of this disclosure, the term “display” may generally refer to a display or screen that is not depicted in the same area as the capacitive reference surface. In some cases, the display is incorporated into a laptop where a keyboard is located between the display and the capacitive reference surface. In some examples where the capacitive reference surface is incorporated into a laptop, the capacitive reference surface may be part of a touch pad. Pressure sensors may be integrated into the stack making up the capacitance module. However, in some cases, the pressure sensors may be located at another part of the laptop, such as under the keyboard housing, but outside of the area used to sense touch inputs, on the side of the laptop, above the keyboard, to the side of the keyboard, at another location on the laptop, or at another location. In examples where these principles are integrated into a laptop, the display may be pivotally connected to the keyboard housing. The display may be a digital screen, a touch screen, another type of screen, or combinations thereof. In some cases, the display is located on the same device as the capacitive reference surface, and in other examples, the display is located on another device that is different from the device on which the capacitive reference surface is located. For example, the display may be projected onto a different surface, such as a wall or projector screen. In some examples, the reference surface may be located on an input or gaming controller, and the display is located on a wearable device, such as a virtual reality or augmented reality screen. In some cases, the reference surface and the display are located on the same surface, but on separate locations on that surface. In other examples, the reference surface and the display may be integrated into the same device, but on different surfaces. In some cases, the reference surface and the display may be oriented at different angular orientations with respect to each other.

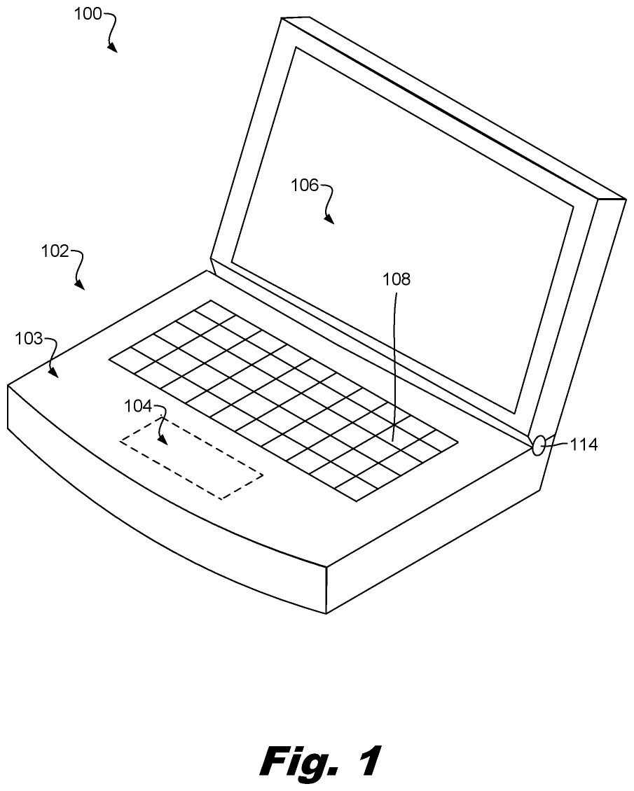

FIG. 1 depicts an example of an electronic device 100. In this example, the electronic device is a laptop. In the illustrated example, the electronic device 100 includes input components, such as a keyboard 102 and a capacitive module, such as a touch pad 104, that are incorporated into a housing 103. The electronic device 100 also includes a display 106. A program operated by the electronic device 100 may be depicted in the display 106 and controlled by a sequence of instructions that are provided by the user through the keyboard 102 and/or through the touch pad 104. An internal battery (not shown) may be used to power the operations of the electronic device 100.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to give different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 is a capacitance module that includes a stack of layers disposed underneath the keyboard housing, underneath an overlay that is fitted into an opening of the keyboard housing, or underneath another capacitive reference surface. In some examples, the capacitance module is located in an area of the keyboard's surface where the user's palms may rest while typing. The capacitance module may include a substrate, such as a printed circuit board or another type of substrate. One of the layers of the capacitance module may include a sensor layer that includes a first set of electrodes oriented in a first direction and a second layer of electrodes oriented in a second direction that is transverse the first direction. These electrodes may be spaced apart and/or electrically isolated from each other. The electrical isolation may be accomplished by deposited at least a portion of the electrodes on different sides of the same substrate or providing dedicated substrates for each set of electrodes. Capacitance may be measured at the overlapping intersections between the different sets of electrodes. However, as an object with a different dielectric value than the surrounding air (e.g., finger, stylus, etc.) approach the intersections between the electrodes, the capacitance between the electrodes may change. This change in capacitance and the associated location of the object in relation to the capacitance module may be calculated to determine where the user is touching or hovering the object within the detection range of the capacitance module. In some examples, the first set of electrodes and the second set of electrodes are equidistantly spaced with respect to each other. Thus, in these examples, the sensitivity of the capacitance module is the same in both directions. However, in other examples, the distance between the electrodes may be non-uniformly spaced to provide greater sensitivity for movements in certain directions.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees or more with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 106 may be orientable with respect to the keyboard 102 at an angle between 35 to 135 degrees when in use by the user. However, in these examples, the display 106 may be positionable at any angle desired by the user.

In some examples, the display 106 may be a non-touch sensitive display. However, in other examples at least a portion of the display 106 is touch sensitive. In these examples, the touch sensitive display may also include a capacitance module that is located behind an outside surface of the display 106. As a user's finger or other object approaches the touch sensitive screen, the capacitance module may detect a change in capacitance as an input from the user.

While the example of FIG. 1 depicts an example of the electronic device being a laptop, the capacitance sensor and touch surface may be incorporated into any appropriate device. A non-exhaustive list of devices includes, but is not limited to, a desktop, a display, a screen, a kiosk, a computing device, an electronic tablet, a smart phone, a location sensor, a card reading sensor, another type of electronic device, another type of device, or combinations thereof.

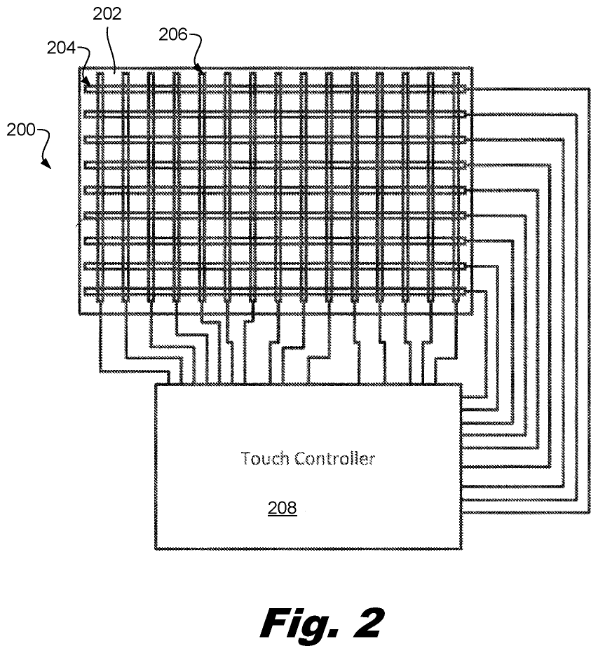

FIG. 2 depicts an example of a portion of a capacitance module 200. In this example, the capacitance module 200 may include a substrate 202, first set 204 of electrodes, and a second set 206 of electrodes. The first and second sets 204, 206 of electrodes may be oriented to be transverse to each other. Further, the first and second sets 204, 206 of electrodes may be electrically isolated from one another so that the electrodes do not short to each other. However, where electrodes from the first set 204 overlap with electrodes from the second set 206, capacitance can be measured. The capacitance module 200 may include one or more electrodes in the first set 204 or the second set 206. Such a substrate 202 and electrode sets may be incorporated into a touch screen, a touch pad, a location sensor, a gaming controller, a button, and/or detection circuitry.

In some examples, the capacitance module 200 is a mutual capacitance sensing device. In such an example, the substrate 202 has a set 204 of row electrodes and a set 206 of column electrodes that define the touch/proximity-sensitive area of the component. In some cases, the component is configured as a rectangular grid of an appropriate number of electrodes (e.g., 8-by-6, 16-by-12, 9-by-15, or the like).

As shown in FIG. 2, the capacitance module 200 includes a capacitance controller 208. The capacitance controller 208 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

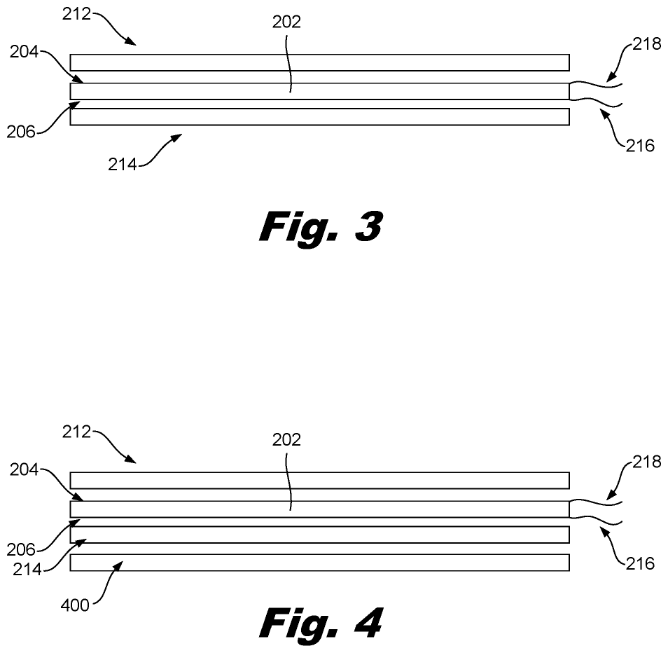

In some cases, the capacitance controller 208 includes at least one multiplexing circuit to alternate which of the sets 204, 206 of electrodes are operating as drive electrodes and sense electrodes. The driving electrodes can be driven one at a time in sequence, or randomly, or drive multiple electrodes at the same time in encoded patterns. Other configurations are possible such as a self-capacitance mode where the electrodes are driven and sensed simultaneously. Electrodes may also be arranged in non-rectangular arrays, such as radial patterns, linear strings, or the like. A shield layer (see FIG. 3) may be provided beneath the electrodes to reduce noise or other interference. The shield may extend beyond the grid of electrodes. Other configurations are also possible.

In some cases, no fixed reference point is used for measurements. The capacitance controller 208 may generate signals that are sent directly to the first or second sets 204, 206 of electrodes in various patterns.

In some cases, the component does not depend upon an absolute capacitive measurement to determine the location of a finger (or stylus, pointer, or other object) on a surface of the capacitance module 200. The capacitance module 200 may measure an imbalance in electrical charge to the electrode functioning as a sense electrode which can, in some examples, be any of the electrodes designated in either set 204, 206 or, in other examples, with dedicated-sense electrodes. When no pointing object is on or near the capacitance module 200, the capacitance controller 208 may be in a balanced state, and there is no signal on the sense electrode. When a finger or other pointing object creates imbalance because of capacitive coupling, a change in capacitance may occur at the intersections between the sets of electrodes 204, 206 that make up the touch/proximity sensitive area. In some cases, the change in capacitance is measured. However, in alternative example, the absolute capacitance value may be measured.

While this example has been described with the capacitance module 200 having the flexibility of the switching the sets 204, 206 of electrodes between sense and transmit electrodes, in other examples, each set of electrodes is dedicated to either a transmit function or a sense function.

FIG. 3 depicts an example of a substrate 202 with a first set 204 of electrodes and a second set 206 of electrodes deposited on the substrate 202 that is incorporated into a capacitance module. The first set 204 of electrodes and the second set 206 of electrodes may be spaced apart from each other and electrically isolated from each other. In the example depicted in FIG. 3, the first set 204 of electrodes is deposited on a first side of the substrate 202, and the second set 206 of electrodes is deposited on the second side of the substrate 202, where the second side is opposite the first side and spaced apart by the thickness of the substrate 202. The substrate may be made of an electrically insulating material thereby preventing the first and second sets 204, 206 of electrodes from shorting to each other. As depicted in FIG. 2, the first set 204 of electrodes and the second set 206 of electrodes may be oriented transversely to one another. Capacitance measurements may be taken where the intersections with the electrodes from the first set 204 and the second set 206 overlap. In some examples, a voltage may be applied to the transmit electrodes and the voltage of a sense electrode that overlaps with the transmit electrode may be measured. The voltage from the sense electrode may be used to determine the capacitance at the intersection where the sense electrode overlaps with the transmit electrode.

In the example of FIG. 3 depicting a cross section of a capacitance module, the substrate 202 may be located between a capacitance reference surface 212 and a shield 214. The capacitance reference surface 212 may be a covering that is placed over the first side of the substrate 202 and that is at least partially transparent to electric fields. As a user's finger or stylus approach the capacitance reference surface 212, the presence of the finger or the stylus may affect the electric fields on the substrate 202. With the presence of the finger or the stylus, the voltage measured from the sense electrode may be different than when the finger or the stylus are not present. As a result, the change in capacitance may be measured.

The shield 214 may be an electrically conductive layer that shields electric noise from the internal components of the electronic device. This shield may prevent influence on the electric fields on the substrate 202. In some cases, the shield is solid piece of material that is electrically conductive. In other cases, the shield has a substrate and an electrically conductive material disposed on at least one substrate. In yet other examples, the shield is layer in the touch pad that performs a function and also shields the electrodes from electrically interfering noise. For example, in some examples, a pixel layer in display applications may form images that are visible through the capacitance reference surface, but also shields the electrodes from the electrical noise.

The voltage applied to the transmit electrodes may be carried through an electrical connection 216 from the capacitance controller 208 to the appropriate set of electrodes. The voltage applied to the sense electrode through the electric fields generated from the transmit electrode may be detected through the electrical connection 218 from the sense electrodes to the capacitance controller 208.

While the example of FIG. 3 has been depicted as having both sets of electrodes deposited on a substrate, one set of electrodes deposited on a first side and a second set of electrodes deposited on a second side; in other examples, each set of electrodes may be deposited on its own dedicated substrate.

Further, while the examples above describe a touch pad with a first set of electrodes and a second set of electrodes; in some examples, the capacitance module has a single set of electrodes. In such an example, the electrodes of the sensor layer may function as both the transmit and the receive electrodes. In some cases, a voltage may be applied to an electrode for a duration of time, which changes the capacitance surrounding the electrode. At the conclusion of the duration of time, the application of the voltage is discontinued. Then a voltage may be measured from the same electrode to determine the capacitance. If there is no object (e.g., finger, stylus, etc.) on or in the proximity of the capacitance reference surface, then the measured voltage off of the electrode after the voltage is discontinued may be at a value that is consistent with a baseline capacitance. However, if an object is touching or in proximity to the capacitance reference surface, then the measured voltage may indicate a change in capacitance from the baseline capacitance.

In some examples, the capacitance module has a first set of electrodes and a second set of electrodes and is communication with a controller that is set up to run both mutual capacitance measurements (e.g., using both the first set and the second set of electrodes to take a capacitance measurement) or self-capacitance measurements (e.g., using just one set of electrodes to take a capacitance measurement).

FIG. 4 depicts an example of a capacitance module incorporated into a touch screen. In this example, the substrate 202, sets of electrodes 204, 206, and electrical connections 216, 218 may be similar to the arrangement described in conjunction with FIG. 3. In the example of FIG. 4, the shield 214 is located between the substrate 202 and a display layer 400. The display layer 400 may be a layer of pixels or diodes that illuminate to generate an image. The display layer may be a liquid crystal display, a light emitting diode display, an organic light emitting diode display, an electroluminescent display, a quantum dot light emitting diode display, an incandescent filaments display, a vacuum florescent display, a cathode gas display, another type of display, or combinations thereof. In this example, the shield 214, the substrate 202, and the capacitance reference surface 212 may all be at least partially optically transparent to allow the image depicted in the display layer to be visible to the user through the capacitance reference surface 212. Such a touch screen may be included in a monitor, a display assembly, a laptop, a mobile phone, a mobile device, an electronic tablet, a dashboard, a display panel, an infotainment device, another type of electronic device, or combinations thereof.

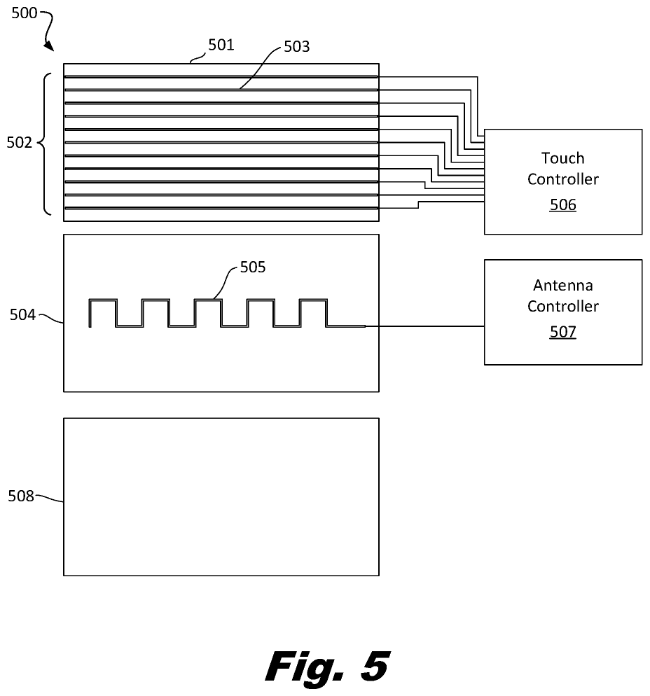

FIG. 5 depicts an example of a stack of layers in accordance with the present disclosure. In this example, a stack of layers 500 includes a sensor layer 501, an antenna layer 504, and a shield layer 508. Although three layers are identified in this example, any appropriate number of layers may be used. For example, a stack may include more or fewer layers than depicted. In some examples, a stack may include two layers, three layers, four layers, six layers, another number of layers, or a combination thereof.

In this example, the sensor layer 501 contains a set 502 of electrodes 503. The electrodes 503 may be transmit electrodes, sense electrodes, or another type of electrode. In this example, the set 502 of electrodes 503 forms a self-capacitance sensor. In some cases, a self-capacitance sensor uses a single set of electrodes to transmit and receive capacitance measurements. While in FIG. 5 the sensor layer 501 contains only one identified set 502 of electrodes 503, a sensor layer may contain a different number of electrode sets. In some examples, a sensor layer may contain two sets of electrodes, three sets of electrodes, or another amount of electrode sets. In examples where a sensor layer contains at least two sets of electrodes, the sets may form a mutual capacitance sensor.

Each electrode 503 in the set 502 may be connected to a capacitance controller 506. The capacitance controller 506 may include at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

The capacitance controller 506 may control the self-capacitance sensor that is formed by the set 502 of electrodes 503. The capacitance controller 506 may generate electrical signals which are applied to the electrodes 503. When a change in capacitance occurs in the set 502 of electrodes 503 as a result of user input, the capacitance controller 506 may sense the change in capacitance and interpret the change as a digital signal.

The capacitance controller 506 may drive at least some of the electrodes 503 in the set of electrodes 502 simultaneously or individually. In some cases, the frequency of the electrical signals which are applied to the electrodes 503 with the capacitance controller 506 may be within a frequency range of 300 kHz to 1.8 MHz.

The antenna layer 504 contains an antenna 505 that is connected to an antenna controller 507. The antenna layer 504 may be a substrate or printed circuit board (PCB). In examples where the antenna layer 504 is made of a substrate, the antenna 505 may be etched or otherwise deposited on the substrate. In examples where the antenna layer 504 is a PCB, the antenna 505 may be printed on the PCB. While this example depicts the antenna layer 504 with a single antenna 505, in other examples, an antenna layer may contain a different number of antennas. For example, an antenna layer may contain two antennas, three antennas, or another number of antennas.

The antenna 505 may be configured to transmit a single wireless communication protocol. While in this example the antenna 505 is configured to transmit one wireless communication protocol, an antenna may be configured to transmit a signal according to multiple different protocols. The antenna 505 may transmit many types of wireless protocols, including but not limited to a Wi-Fi protocol, a short-range wireless protocol, a near field communication (NFC) protocol, Zigbee protocol, or another type of protocol. In examples where an antenna is configured to transmit a signal according to multiple different protocols, the antenna may be used to transmit any combination of the wireless protocols listed.

In this example, the antenna 505 has a square wave shape. This shape of an antenna may be used to transmit a wireless signal according to a Wi-Fi protocol or short-range wireless protocol. While this example shows an antenna with a square wave shape, other shapes of antenna are possible. For example, an antenna may have a square shape, a spiral shape, another shape, a linear shape, or combinations thereof.

The antenna 505 is connected to the antenna controller 507 that may control the antenna. In order to transmit a wireless signal, the antenna controller 507 may apply a voltage to the antenna 505 which causes an electromagnetic wave to propagate from the antenna. In order to receive a wireless signal, an electromagnetic wave passing over the antenna 505 induces a voltage which is interpreted by the antenna controller 507.

The frequency of the electromagnetic waves which are either transmitted or received by the antenna 505 of the antenna layer 504 may oscillate according to a specific frequency. The frequency of the wave may vary depending on the wireless protocol used by the antenna 505. For example, an electromagnetic wave that transmits a signal according to a Wi-Fi protocol may oscillate at a frequency of 2.4 GHz or 5 GHz, whereas an electromagnetic wave that transmits an NFC protocol may oscillate at a frequency of 13.56 MHz.

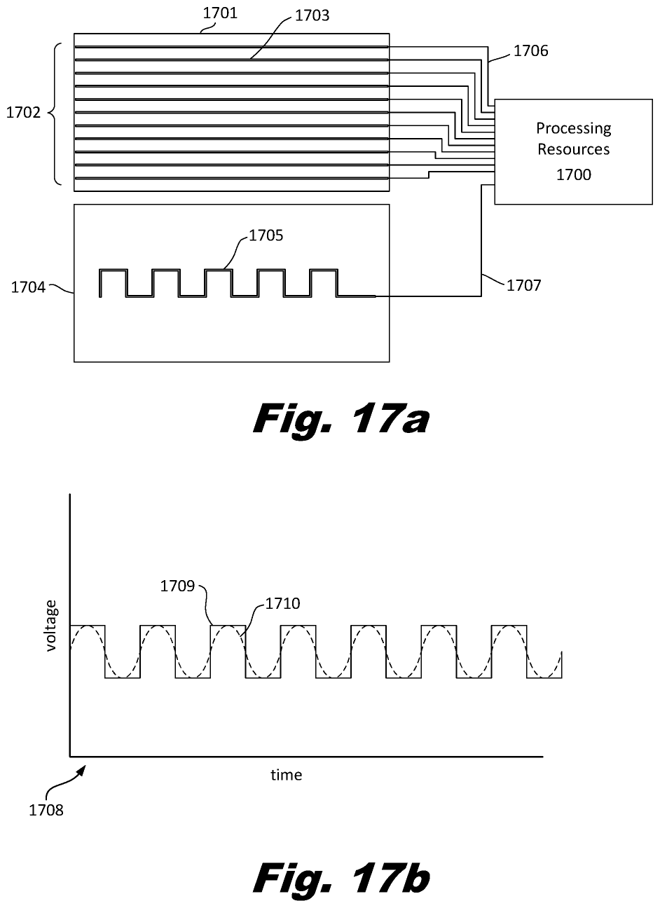

In this example, the frequency range of the signals that are transmitted or received by the antenna 505 is outside of the frequency range of the electrical signals that operate the electrodes 503 of the sensor layer 501. In this way, the antenna layer 504 may be adjacent to the sensor layer 501 and the transmission of the antenna 505 on the antenna layer may not cause interference with the electrodes 503. In other examples (see FIG. 17a & FIG. 17b), the frequencies of the antenna signal and electrodes may overlap.

The sensor layer 501 and antenna layer 504 are on one side of a shield layer 508. The shield layer 508 may block electrical signals that may interfere with the functioning of the electrodes 503 on the sensor layer 501 or the antenna 505 on the antenna layer 504. The shield layer 508 may be made out of copper, aluminum, or other appropriate shielding material. The shield material may be etched, printed, or otherwise deposited on a substrate of the shield layer 508.

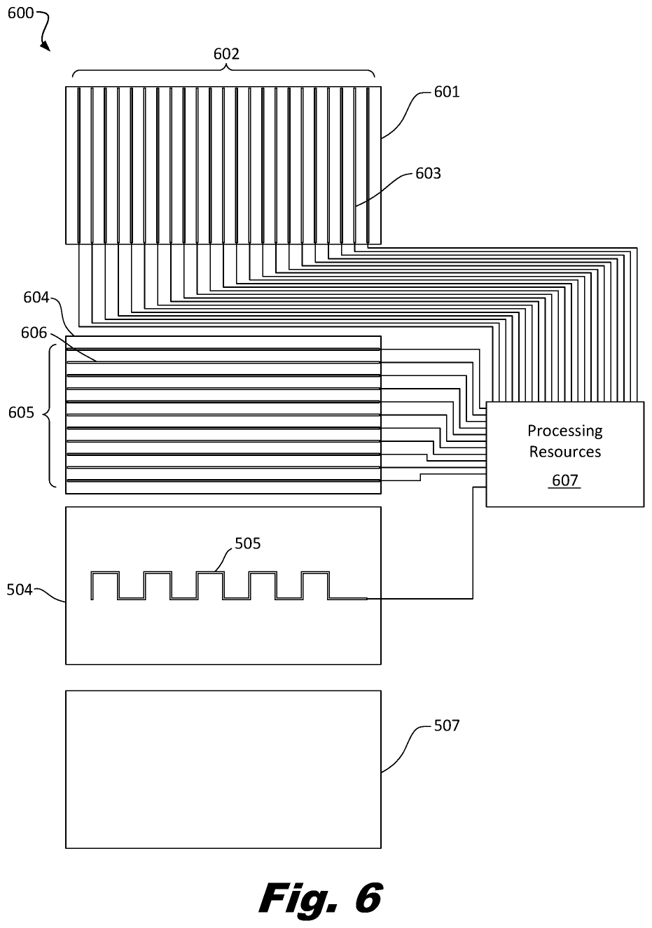

FIG. 6 depicts an example of a stack of layers 600 in accordance with the disclosure. In this example a first sensor layer 601 and a second sensor layer 604 are adjacent to each other. The first sensor layer 601 contains a first set 602 of electrodes 603, whose electrodes 603 may be sense electrodes, transmit electrodes, or another type of electrodes. The second sensor layer 604 contains a second set 605 of electrodes 606 that may be sense electrodes, transmit electrodes, or another type of electrodes. In this example, the electrodes 603 of the first set 602 are transversely oriented from the electrodes 606 on the second set 602. Together, the first set 602 and second set 605 of electrodes form a mutual capacitance sensor.

In this example, the electrodes 603, 606 of the first set 602 and second set 605 of electrodes, as well as the antenna 505 are connected to processing resources 607. In some cases, processing resources includes one or more processors. The processing resources may be located on one of the layers in the stack of layers. In other examples, the processing resources may be located off of the stack of layers, but may communicate with components in the stack of layers. The processing resources 607 may control the behavior of the electrodes 603, 606 and the antenna 505. The processing resources 607 may generate voltages that are applied to the electrodes 603, 606 and/or the antenna 505. The processing resources 607 may also sense voltages that come from the antenna 505 and interpret the voltages according to a wireless signal protocol.

The stack of layers in FIG. 6 depicts the first and second sensor layers 601, 604 adjacent to each other, and the antenna layer 504 between the first and second sensor layers 601, 604 and the shield layer 507. While this example shows the antenna layer 504 located between the shield layer 507 and the first and second sensor layers 601, 604; in other examples, an antenna layer may be located differently in the stack. For example, an antenna layer may be located between a first sensor layer and a second layer, or a sensor layer may be located between an antenna layer and a shield layer.

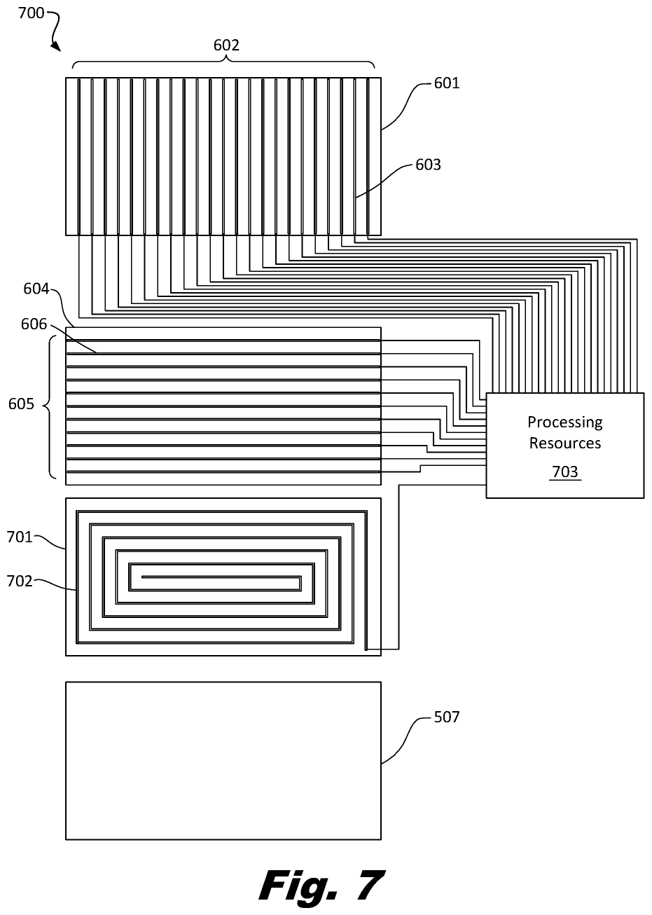

FIG. 7 depicts an example of a stack of layers 700 in accordance with the disclosure. In this example, an antenna 702 on an antenna layer 701 has a spiral shape. This shape of antenna may be used to transmit a wireless signal according to an NFC protocol.

In some examples, the antenna 702 is connected to the processing resources 703. The processing resources 703 may also be connected to the electrodes 603, 606 of the first and second set of electrodes 602, 605. The processing resources 703 may operate the antenna 702 and the electrodes 603, 606.

In some cases, the processing resources include a processor dedicated to controlling the electrodes and another processor for controlling the antenna. In other examples, the single processor may include logic to operate at least some of the electrodes and the antenna. In other cases, multiple processors may be used to operate the electrodes, the antenna, or combinations thereof.

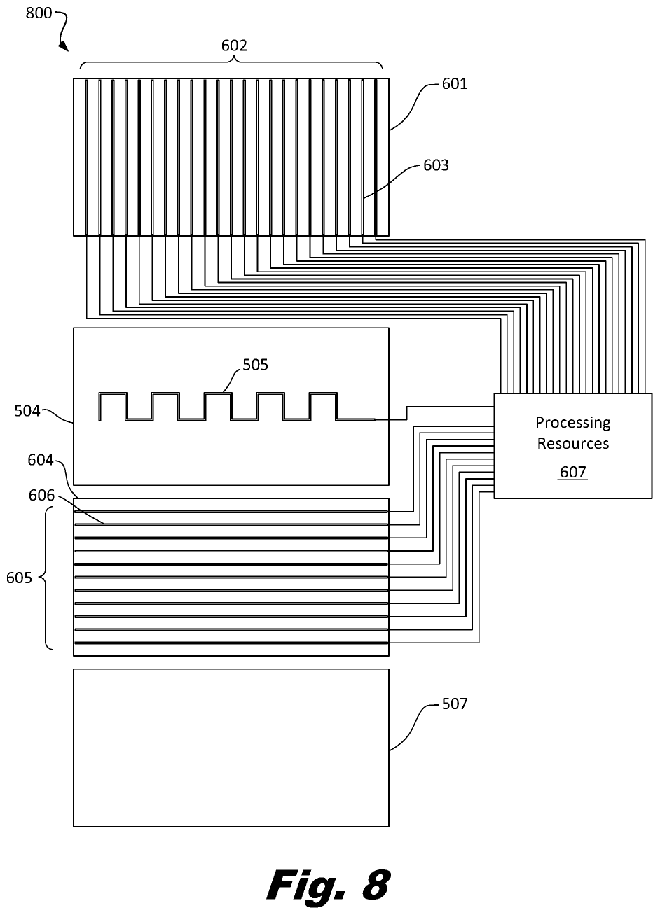

FIG. 8 depicts an example of a stack of layers 800 in accordance with the disclosure. In this example, the antenna layer 504 is between the first sensor layer 601 and second sensor layer 604. Each of the sensor layers 601, 604 and antenna layer 504 may be located adjacent to the same side of shield layer 507. The processing resources 607 may operate both the antenna 505 and the electrodes 603, 606.

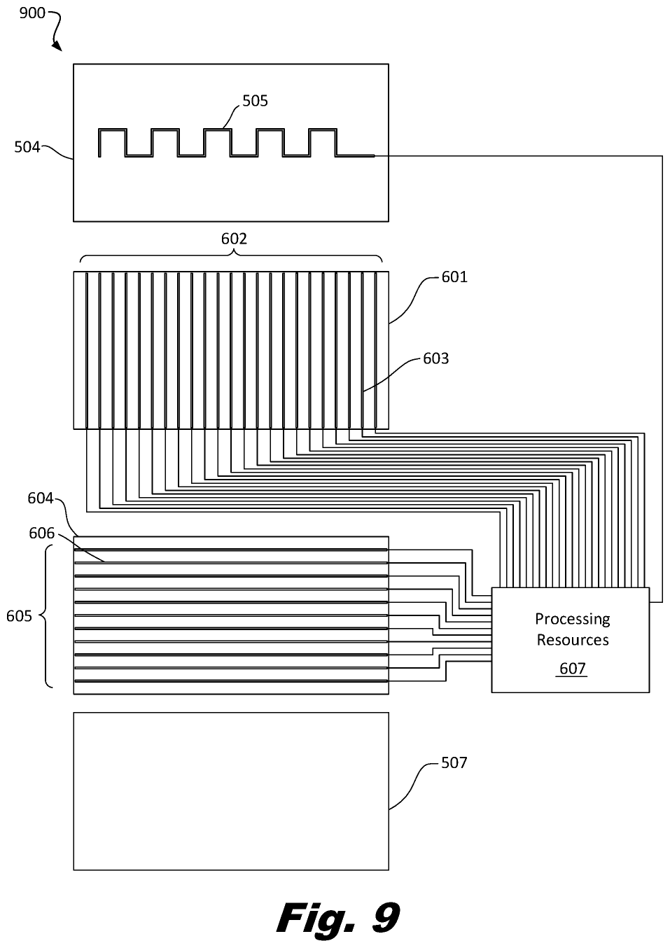

FIG. 9 depicts an example of a stack of layers 900 in accordance with the disclosure. In this example, the first and second sensor layers 601, 604 are adjacent to each other and between the antenna layer 504 and the shield layer 507. In examples where sensor layers are between an antenna layer and a shield layer, the sensitivity of electrodes on the sensor layer or layers may be adjusted to be sensitive to input.

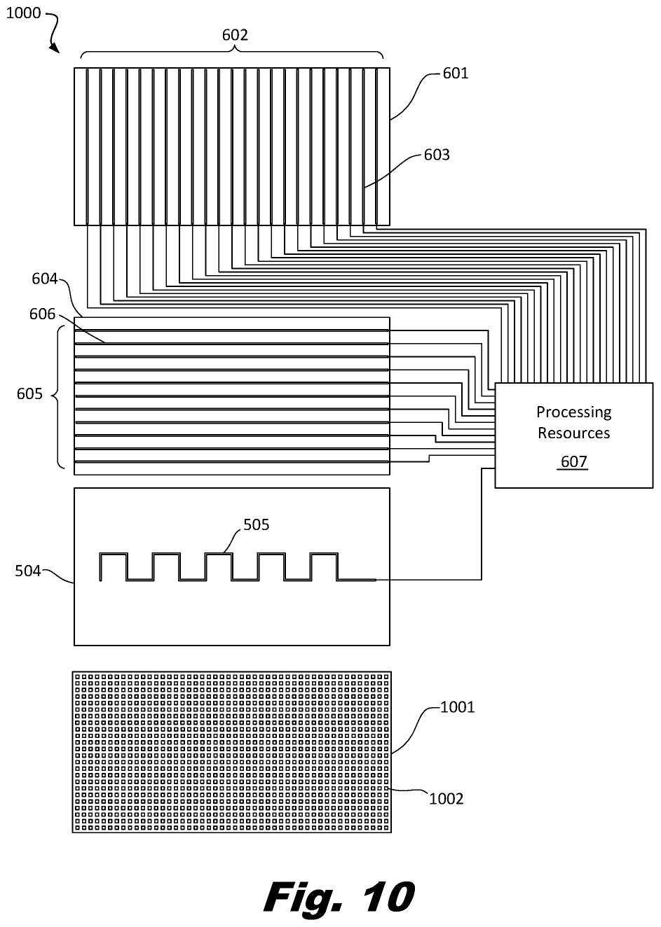

FIG. 10 depicts an example of a stack of layers 1000 in accordance with the disclosure. In this example, a display layer 1001 is in the stack of layers 1000. The display layer may include pixels 1002. The pixels 1002 may be illuminated by a controller. In some examples, the display layer 1001 may be a liquid crystal display (LCD), a light emitting diode display (LED), an organic light emitting diode display (OLED), a quantum dot display (QLED), another type of display, or a combination thereof.

In examples where a stack of layers includes a display layer and the components of the display layer shield at least some electrically interfering noise, the display layer may also be the shield layer.

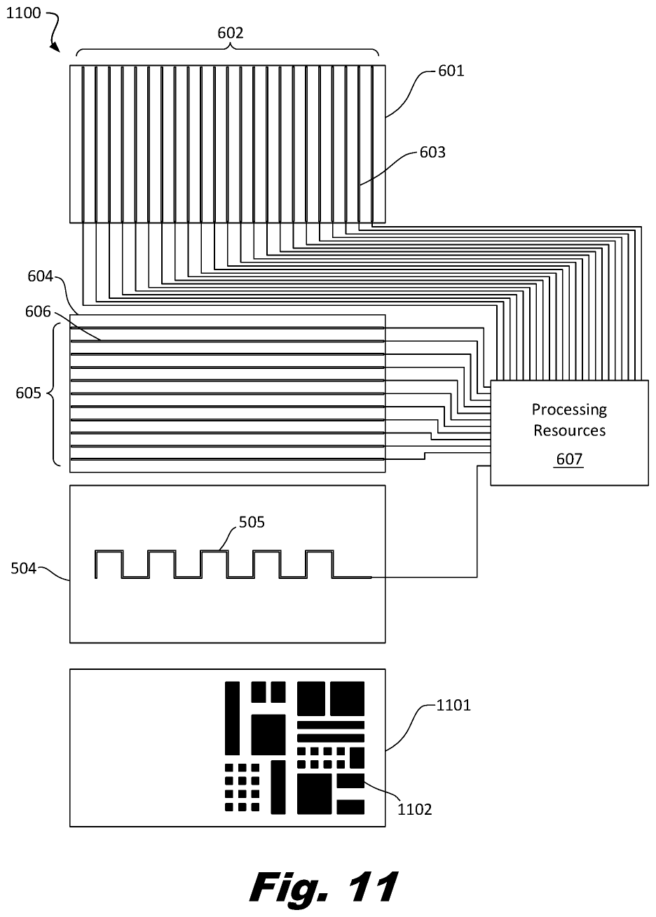

FIG. 11 depicts an example of a stack of layers 1100 in accordance with the disclosure. In this example, a shield layer 1101 includes components 1102 that have other functions than to merely shield electrical interfering noise. The components 1102 may be included on the shield layer 1101, rather than on another layer, to reduce the number of layers in the stack. Components may include but are not limited to a central processing unit (CPU), a digital signal processor (DSP), an analog front end (AFE), an amplifier, a peripheral interface controller (PIC), another type of microprocessor, an integrated circuit, a field programmable gate array (FPGA), an application specific integrated circuit (ASIC), a combination of logic gate circuitry, other types of digital or analog electrical components, or combinations thereof.

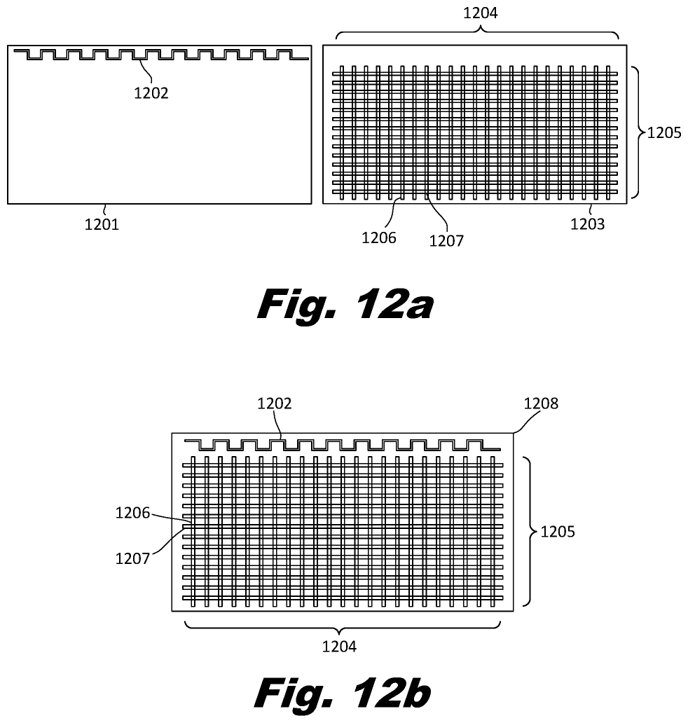

FIG. 12a depicts an example an antenna layer 1201 and sensor layer 1203 in accordance with the present disclosure. For illustrative purposes, the antenna layer 1201 and sensor layer 1203 are pictured side by side.

The antenna layer 1201 contains an antenna 1202. In this example, the antenna 1202 is shaped like a square wave, although in other examples, an antenna may have a different shape. This shape of antenna may be used to transmit a wireless signal according to a Wi-Fi protocol or short-range wireless protocol. The antenna 1202 is formed on a portion of the antenna layer 1201.

The sensor layer 1203 contains a first set of electrodes 1204 and a second set of electrodes 1205. The first set of electrodes 1204 contains electrodes 1206 that are placed along the length of the sensor layer 1203, whereas the second set of electrodes 1205 contains electrodes 1207 that are placed along the width of the sensor layer. The first and second set of electrodes 1204 and 1205 form a mutual capacitance sensor.

Where an electrode from the first set of electrodes 1204 overlaps with an electrode from the second set of electrodes 1205, one of the electrodes may be routed through vias in the substrate of the sensor layer 1203. By routing one electrode through the substrate, the two electrodes may be spaced apart from each other to be electrically isolated from each other to prevent the two from shorting.

FIG. 12b depicts an example of an antenna formed on a sensor layer in accordance with the present disclosure. The antenna 1202 is formed on a portion of the sensor layer 1208 and the first and second set of electrodes 1204, 1205 occupy a lower portion of the senor layer. Placing the antenna 1202 on the same layer as the mutual capacitance sensor may present a few advantages: the number of layers in a stack of layers may be reduced and the overall thickness of an apparatus may be reduced as well.

Although in this example the antenna 1202 does not overlap with the first and second set of electrodes 1204, 1205, in other examples, the two elements may overlap. For example, a mutual capacitance sensor may overlap with a portion of an antenna, or even all of an antenna.

The antenna 1202 and the mutual capacitance sensor formed by the first set of electrodes 1204 and second set of electrodes 1205 may operate within different frequency ranges. For example, the mutual capacitance sensor may operate within a frequency range of 300 kHz to 1.8 MHz, while the electrodes 1206, 1207 of the mutual capacitance sensor may operate within a frequency range of 13.56 MHz to 5 GHz. In some cases where the antenna 1202 and mutual capacitance sensor operate within different frequency ranges, they may be placed on the same layer without interfering with the other's operation.

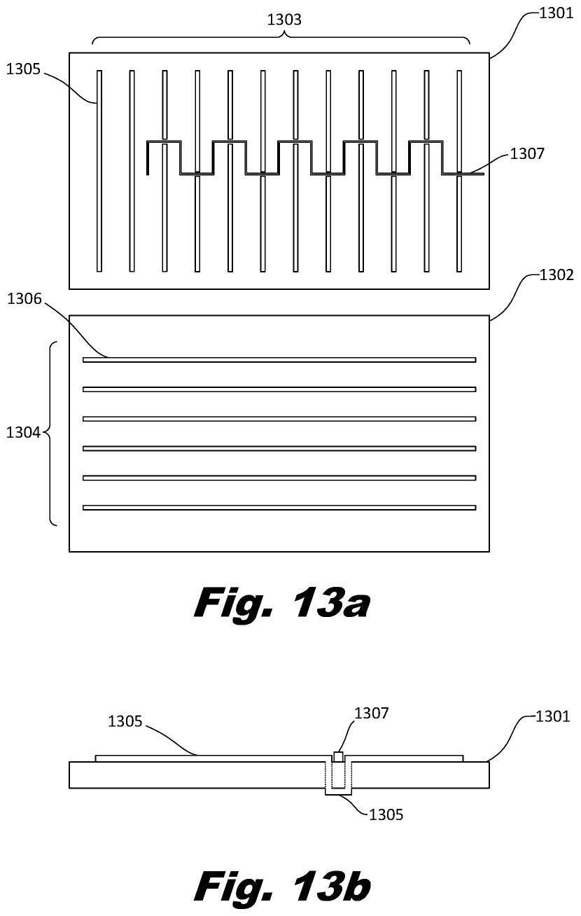

FIG. 13a depicts an example of sensor layers in accordance with the present disclosure. In this example, a first sensor layer 1301 contains a first set of electrodes 1303. A second sensor layer 1302 contains a second set of electrodes 1304. The first set of electrodes 1303 contains electrodes 1305 which are placed along the length of the first sensor layer 1301. The electrodes 1305 may be sense electrodes, transmit electrodes, or another type of electrodes. The second set of electrodes 1304 contains electrodes 1306 which are placed along the width of the second sensor layer 1302. The electrodes 1306 may be sense electrodes, transmit electrodes, or another type of electrodes. The first sensor layer 1301 and second sensor layer 1302 may be positioned adjacent to each other in a stack of layers. Together, the first set of electrodes 1303 and second set of electrodes 1304 form a mutual capacitance sensor.

An antenna 1307 is formed on the first sensor layer 1301. While this example depicts the antenna 1307 formed on the first sensor layer 1301, an antenna may be formed on another sensor layer within a stack of layers. For example, an antenna may be formed on a first sensor layer, second sensor layer, or another sensor layer. Additionally, while this example depicts one antenna formed on a sensor layer, multiple antennas may be formed on a sensor layer. For example, a sensor layer may contain one antenna, two antennas, three antennas, a different number of antennas, or combinations thereof.

The antenna 1304 is shaped like a square wave. This shape of antenna may be used to transmit a wireless signal according to a Wi-Fi protocol or short-range wireless protocol. An antenna on a sensor layer may have a different shape. For example, an antenna may have a square shape, spiral shape, another shape, or a combination thereof.

Where the antenna 1307 overlaps with the electrodes 1305 from the first set of electrodes 1303, the electrodes may be routed through vias (see FIG. 13b) in the substrate of the first sensor layer 1301. By routing the electrodes 1305 through the substrate, the antenna 1307 and electrodes 1305 may remain electrically isolated from each other, which may prevent interference to the electrodes by the antenna and interference to the antenna by the electrodes.

The antenna 1304 and mutual capacitance sensor may operate within different frequency ranges that are offset from each other. In some cases, when the frequency ranges of the antenna 1304 and mutual capacitance sensor do not overlap, the antenna 1307 and electrodes 1305 may be placed on the same layer 1301 without interfering in the other's operation. Although in this example, the frequency ranges are offset, in other examples, the frequency ranges of an antenna and capacitance sensor may overlap. In some cases, the characteristics of the electrode frequency range do not cause interference with the antenna. Further, in some cases, the characteristics of the antenna frequency range do not cause interference with the electrodes of the capacitance sensor.

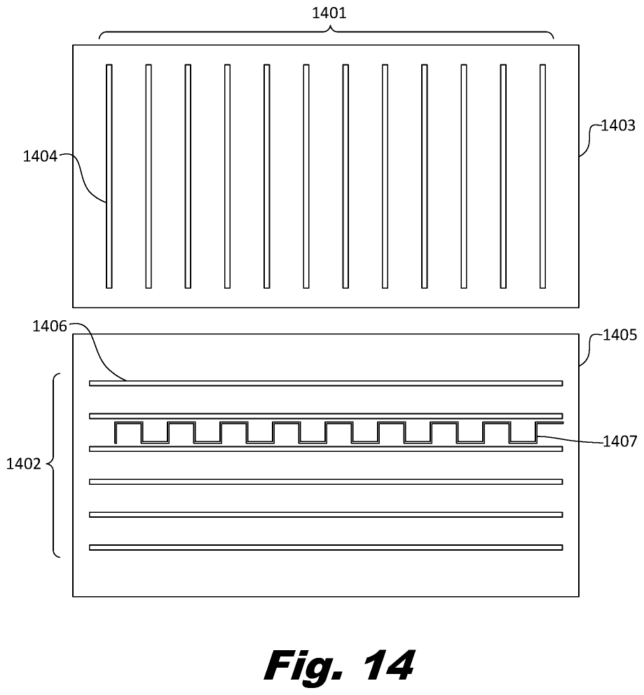

FIG. 14 depicts an example of sensor layers in accordance with the disclosure. In this example, a first sensor layer 1403 contains a first set 1401 of electrodes 1404. The first set 1401 of electrodes 1404 that are placed along the length of the sensor layer 1403. A second sensor layer 1405 contains a second set 1402 of electrodes 1406. The second set 1402 of electrodes 1406 that are placed along the width of the sensor layer 1405. Together, the first set 1401 and second set 1402 form a mutual capacitance sensor.

The second sensor layer 1405 contains an antenna 1407. The antenna 1407 has a square wave shape. The antenna 1407 is between electrodes 1406 of the second set of electrodes 1402. The antenna 1407 may operate without interfering with the electrodes 1406 of the second set of electrodes 1402. In some cases, placing the antenna 1407 in between electrodes 1406, the mutual capacitance sensor, formed by the first and second set of electrodes 1401, 1402, may operate more effectively.

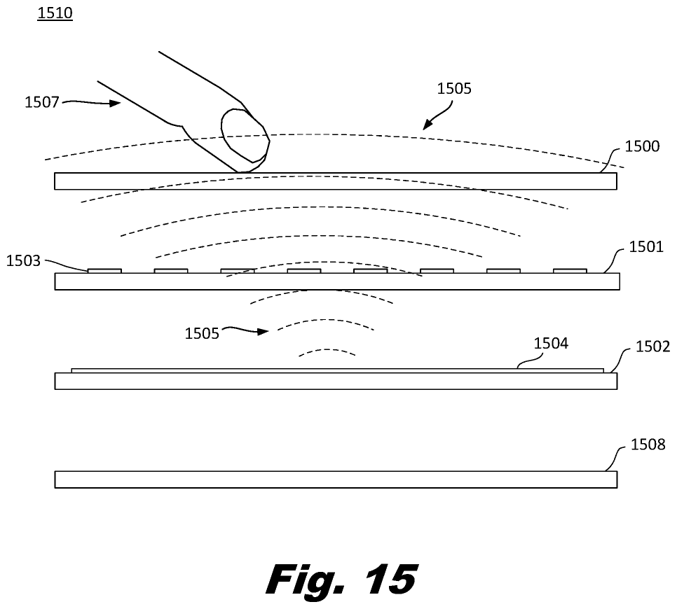

FIG. 15 depicts an example of a capacitance module 1510 in accordance with the disclosure. The capacitance module 1510 contains four layers, a reference surface 1500, a sensor layer 1501, an antenna layer 1502, and a shield layer 1508 respectively. Although four layers are identified in this example, a capacitance module may include more or less layers. In some examples, a capacitance module may contain two layers, three layers, four layers, a different number of layers, or combinations thereof. Additionally, the relative position of each layer in a capacitance module may also be different than the positions depicted in this example. For example, although the electrode layer 1501 is in between the reference surface 1500 and the antenna layer 1502 in FIG. 15, in other examples, an antenna layer and electrode layer may be switched so that the antenna layer is between the electrode layer and a reference surface.

The reference surface 1500 may be made out of a material that an electric field or wireless transmission can pass through. The reference surface 1500 may be made of glass, plastic, a different material, or a combination thereof.

A user interacts with the capacitance module 1510 by contacting the reference surface 1500 with a finger 1507 or other input method such as a stylus. When the finger 1507 contacts the reference surface 1500, the electric field 1506 created by electrodes 1503 is changed, and sense electrodes on the sensor layer 1501 detect the change. When the change is interpreted by the processing resources, a touch by the user is registered as a digital signal.

Adjacent to the reference surface 1500 is the sensor layer 1501. The sensor layer 1501 contains electrodes 1503. The electrodes 1503 may be transmit electrodes, sense electrodes, or another type of electrodes. The electrodes 1503 on the sensor layer 1501 form a capacitance sensor. The electrodes 1503 are driven by an electrical signal whose frequency range may be between 300 kHz and 1.8 MHz. When an electrical signal is applied to the electrodes 1503, an electric field may be emitted from the electrodes. The change in the electric field enables the operation of the capacitance sensor.

Adjacent to the sensor layer 1501 is the antenna layer 1502. The antenna layer 1502 contains an antenna 1504 which may transmit a wireless signal 1505. The wireless signal 1505 may pass through the sensor layer 1501 and the touch surface 1500. The frequency of the wireless signal 1505 may be between 13.56 MHz and 5 GHz. In some cases when the frequency range of the antenna transmission is outside the frequency range of the electrical signal of the electrodes 1503, the wireless signal 1505 may pass through the sensor layer 1501 without interfering with the operation of the capacitance sensor formed by the electrodes 1503.

Adjacent to the antenna layer 1502 is the shield layer 1508. The shield layer may be constructed to minimize electrical noise that might interfere with the operation of the antenna 1504 and capacitance sensor that is formed by the electrodes 1503. The shield layer may be constructed of a material that blocks electrical signals, such as copper, aluminum, and/or other appropriate shielding material. The shield material may be etched, printed, or otherwise deposited on a substrate of the shield layer 1508.

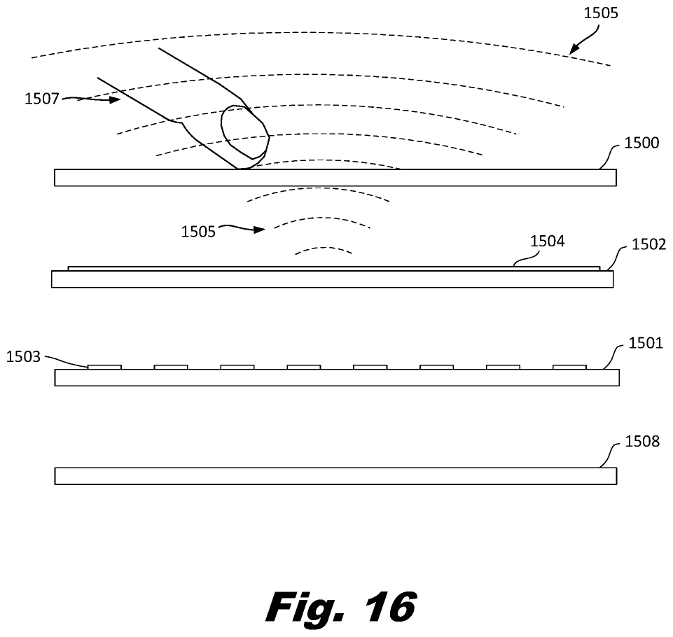

FIG. 16 depicts an example of a capacitance module in accordance with the disclosure. In this example, the antenna layer 1502 is positioned between the reference surface 1500 and sensor layer 1501.

FIG. 17a depicts an example of a stack of layers in accordance with the disclosure. In this example, a sensor layer 1701 contains a set of electrodes 1702. The set of electrodes 1702 contains electrodes 1703 placed along the width of the sensor layer 1701. The set of electrodes may form a self-capacitance sensor. Each electrode 1703 in the set of electrodes 1702 is connected to processing resources 1700 by an electrode lead 1706. The electrodes 1703 operate within a first frequency range.

An antenna layer 1704 is adjacent to the sensor layer 1701. The antenna layer 1704 contains an antenna 1705 that has a square wave shape. The antenna 1705 is connected to the processing resources 1700 by an antenna lead 1707. The antenna 1705 transmits a wireless signal whose frequency is within a second frequency range.

In this example, the first frequency range of the electrodes and the second frequency range of the antenna may overlap. In order to reduce interference with overlapping frequencies, the processing resources 1700 may drive the antenna 1705 with a digital signal and the electrodes 1703 with an analog signal. Driving the electrodes 1703 with the analog signal may minimize the electrodes susceptibility to electrical interference. In this way, even though the antenna 1705 and electrodes 1703 may operate in overlapping or similar frequencies, the interference between the two may be reduced. In some examples, the antenna may be caused to operated based on an analog signal to help reduce electrical interference.

FIG. 17b depicts an example of multiple signals in accordance with the disclosure. A graph 1708 shows voltage versus time. A digital signal 1709 and an analog signal 1710 are plotted on the graph 1708. The digital signal 1709 and analog signal 1710 have identical wavelengths, amplitudes, and frequencies, but each have different waveshapes. The digital signal 1709 has a square wave shape, while the analog signal 1710 has a sine wave shape. The digital signal 1709 corresponds to the signal that may be transmitted by the antenna 1705 on the antenna layer 1704. The analog signal 1710 corresponds to the signal that may drive the electrodes 1703 that form the self-capacitance sensor on the sensor layer 1701.

While the example in FIG. 17b depicts the analog signal and the digital signal having a similar frequency, in some examples, the analog signal and the digital signals may be dissimilar. For example, the analog signal and the digital signal may have different frequencies, different amplitudes, different phases, other differences, or combinations thereof.

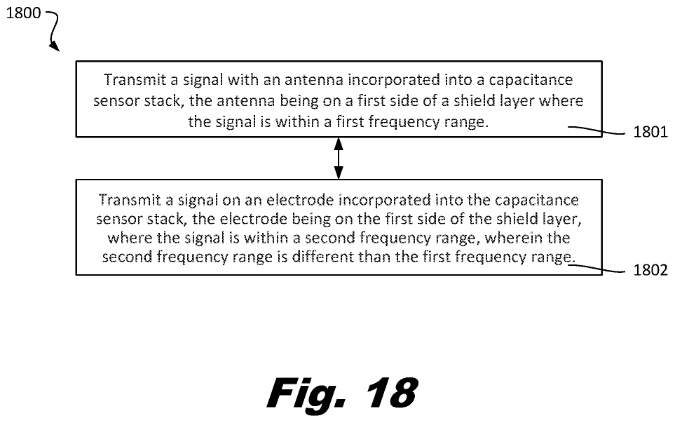

FIG. 18 depicts a method 1800 for transmitting a wireless signal in accordance with the disclosure. This method 1800 may be performed based on the description of the devices, modules, and principles described in relation to FIGS. 1-17b. In this example, the method 1800 includes transmitting 1801 a signal with an antenna incorporated into a capacitance sensor stack, where the antenna is on a first side of a shield layer and the signal is within a first frequency range; and transmitting 1802 a signal on an electrode incorporated into the capacitance sensor stack, where the electrode is on the first side of the shield layer, the signal is within a second frequency range, and the second frequency range is different than the first frequency range.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. An apparatus, comprising:
a stack of layers, the stack including:
a shield layer having a first surface;
at least one capacitive sensor layer of the stack of layers being disposed within a first portion of the stack of layers;
wherein the first portion of the stack of layers is located adjacent to the first surface of the shield layer;
the at least one capacitive sensor layer having at least one set of electrodes where the electrodes are in communication with processing resources;
wherein the processing resources are programmed to operate the at least one set of electrodes within a first frequency range; and
an antenna incorporated within the first portion of the stack of layers where the antenna is in communication with the processing resources;
wherein the processing resources are programmed to operate the antenna within a second frequency range that is different from the first frequency range.

2. The apparatus of claim 1, wherein the processing resources include a controller that includes antenna logic and capacitance logic.

3. The apparatus of claim 1, wherein the processing resources drive an analog signal on the capacitive sensor and drive a digital signal on the antenna.

4. The apparatus of claim 1, wherein the antenna is formed on an antenna layer in the stack of layers.

5. The apparatus of claim 1, wherein the at least one sensor layer includes a first sensor layer and a second sensor layer, and the antenna is between the first sensor layer and the second sensor layer.

6. The apparatus of claim 1, wherein the antenna is deposited on the at least one sensor layer.

7. The apparatus of claim 6, wherein the antenna is within a capacitance sensing region of the at least one sensor layer.

8. The apparatus of claim 6, wherein the antenna is outside of a capacitance sensing region of the at least one sensor layer.

9. The apparatus of claim 1, wherein the first frequency range and the second frequency range do not overlap.

10. The apparatus of claim 1, wherein the first frequency range and the second frequency range overlap.

11. The apparatus of claim 1, wherein the antenna is configured to transmit a wireless signal according to a Wi-Fi protocol.

12. The apparatus of claim 1, wherein the antenna is configured to transmit a wireless signal according to a short-range wireless protocol.

13. The apparatus of claim 1, wherein the antenna is configured to transmit a wireless signal according to a Near Field Communication (NFC) protocol.

14. The apparatus of claim 1, wherein the apparatus is a capacitance display screen.

15. The apparatus of claim 1, wherein the first set of electrodes and second set of electrodes are formed on the same layer to form one sensor layer.

16. The apparatus of claim 1, wherein a component layer is combined with the shield layer to form a combined shield-component layer.

17. The apparatus of claim 1, wherein the first and second electrodes layers in the at least one capacitive sensor layer comprise a mutual capacitance sensor.

18. The apparatus of claim 1, wherein the first and second electrode layers in the at least one capacitive sensor layer comprise a self-capacitance sensor.

19. A method for transmitting a wireless transmission, comprising:
transmitting a signal with an antenna incorporated into a capacitance sensor stack and being on a first side of a shield layer where the signal is within a first frequency range; and
transmitting a signal on an electrode incorporated into the capacitance sensor stack and being on the first side of the shield layer where the signal is within a second frequency range, wherein the second frequency range is different than the first frequency range.

20. An apparatus, comprising:
a stack of layers, the stack including:
a shield layer having a first surface;
at least one capacitive sensor layer of the stack of layers being disposed within a first portion of the stack of layers;
wherein the first portion of the stack of layers is located adjacent to the first surface of the shield layer;
the at least one capacitive sensor layer having at least one set of electrodes; and
an antenna incorporated within the first portion of the stack of layers.
